(19) United States
(12) Patent Application Publication
(10) Pub. No.: US 2007/0186739 A1
(43) Pub. Date: Aug. 16, 2007

(54) Riving knife clamp for a table saw

(75) Inventors: David G. Peot, Easley, SC (US); William C. Buck, Clemson, SC (US)

Correspondence Address: BRINKS HOFER GILSON & LIONE, P.O. BOX 10395, CHICAGO, IL, 60610, US

(73) Assignee: Eastway Fair Company Limited of Trident Chambers

(21) Appl. No.: 11/355,466

(22) Filed: Feb. 16, 2006

(51) Int. Cl. B23D 45/06

(52) U.S. Cl. 83/102.1; 83/477.2

(57) ABSTRACT

A table saw comprising a table including an aperture to receive a portion of a rotatable saw blade extending from below the table and a riving knife extending through the aperture from below the table. The riving knife includes a slot that receives a first pin and the riving knife includes a plurality of recesses. A cam that operatively engages the first pin and is rotatable to cause linear motion of the first pin with respect to the slot such that when the cam is in a first position the riving knife may be retained in a selected position and when the cam is in a second position the riving knife may be movable to another selected position, wherein the rotation of the cam additionally causes movement of a second pin that may be received within one of the plurality of recesses.

### BACKGROUND

Typical table saws include a base or frame having a flat table top or supporting a flat table top. The table top generally includes a slot through which a cutting member, such as a circular saw, protrudes above the table top. Often, a riving knife, or splitter, is mounted directly in-line with the saw blade. The riving knife operates to keep the two portions of the workpiece that have been cut separate to prevent the workpiece from binding on the saw blade. The arrangement of the table saw with a riving knife reduces the possibility of workpiece kickback. Many table saws also include a guard to protect the operator from potentially serious injury caused by accidental contact with the saw blade. The guard is provided to prevent the operator from contacting the saw blade while in use.

Many types of riving knives and guard assemblies have been used in the past. However, these assemblies have often been difficult to use because they are typically flimsy or obstruct the operator's view of the workpiece with respect to the saw blade, or reference marks or scales used to align the workpiece. As a result, many users remove the guard and the riving knife while operating the table saw, which results in a higher probability of accidents and injuries. Additionally, the removal and replacement of the guard and the riving knife often requires multiple procedural steps that make the process of removing and replacing these components complicated and difficult, such that the user often removes these components for a specific project and never replaces them.

Accordingly, it is desired to provide a guard and a riving knife that protect the user from accidentally contacting the rotating saw blade during operation, while providing the user with a sufficient viewing area of the contact between the workpiece and the saw blade. It is desired to provide a riving knife that is easily movable with respect to the saw blade to allow the user to make non-through cuts on a work piece without the inconvenience of fully removing the riving knife from the table saw.

### BRIEF SUMMARY

A table saw is provided that includes a table with an aperture to receive a portion of a rotatable saw blade that extends from below the table and a riving knife that extends through the aperture from below the table. The riving knife includes a slot that receives a first pin to retain the riving knife in a selected position with respect to the saw blade and the riving knife includes a plurality of recesses. A cam is additionally provided and is supported by the table. The cam is rotatable and operatively connected with the first pin such that when the cam is in a first position the riving knife may be retained in a selective position and when the cam is in a second position the riving knife is movable to another selective position. The cam additionally may cause movement of a second pin that may be received within one of the plurality of recesses.

Advantages of the present invention will become more apparent to those skilled in the art from the following description of the preferred embodiments of the invention that have been shown and described by way of illustration. As will be realized, the invention is capable of other and different embodiments, and its details are capable of modification in various respects. Accordingly, the drawings and description are to be regarded as illustrative in nature and not as restrictive.

### BRIEF DESCRIPTION OF THE DRAWINGS

The features and advantages of the present invention may be better understood by reference to the accompanying drawings in which like reference numerals refer to like elements.

FIG. 1 is a perspective view of a table saw incorporating a riving knife/guard assembly according to the present invention.

FIG. 2 is a side view of the table saw showing the riving knife in a first position.

FIG. 3 is the side view of FIG. 2 showing the riving knife in a second position.

FIG. 4 is a perspective view of an embodiment of a riving knife adjustment mechanism.

FIG. 5 is a perspective view of the riving knife adjustment mechanism of FIG. 4 with the plug removed.

FIG. 6 is a top cross-sectional view of the mechanism of FIG. 4.

FIG. 7 is a perspective view of the bracket, the cam, and the first pin of the mechanism of FIG. 4.

FIG. 8 is a top view of the mechanism of FIG. 4 showing the cam in a first position showing hidden lines of the mechanism.

FIG. 9 is the view of FIG. 8 showing the cam between the first and a second position showing hidden lines of the mechanism.

FIG. 10 is the view of FIG. 8 showing the cam in the second position showing hidden lines of the mechanism.

FIG. 11 is a side view of the riving knife adjustment mechanism of FIG. 4 with the clamp plate removed.

FIG. 12 is a top view a second preferred riving knife adjustment mechanism showing the cam in a locked position with the plug removed and showing hidden lines of the mechanism.

FIG. 13 is the view of FIG. 12 showing the cam in the unlocked position showing hidden lines of the mechanism.

FIG. 14 is a perspective view of the mechanism of FIG. 12 with the housing and the clamp plate removed.

FIG. 15 is an alternate perspective view of the mechanism of FIG. 12.

### DETAILED DESCRIPTION

While this invention is susceptible of several different embodiments, this specification and the accompanying drawings disclose only some specific forms as examples of the invention. The invention is not intended to be limited by the descriptions in this specification or the drawings. Instead, the scope of the invention is provided in the claims.

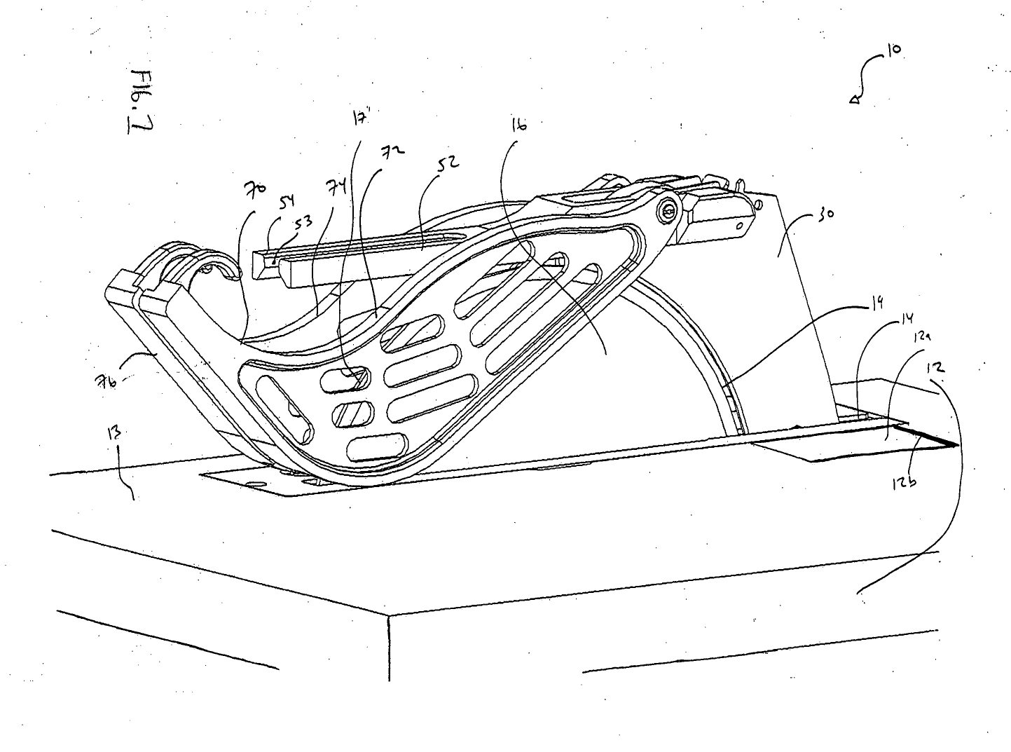

Turning now to FIGS. 1-9, a table saw 10 having one embodiment of the inventive riving knife/guard assembly is provided. The table saw 10 includes a table 12 with a top surface 13. The table 12 includes a slot, or aperture, 14 that extends through the table 12. A saw blade 16 is conventionally mounted to a motor and carriage (both not shown) that is located under the table 12. A portion of the saw blade 16 protrudes through the slot 14. The portion of the blade 16 that protrudes through the slot 14 is the operative portion for cutting a workpiece (not shown). The knife/guard assembly 20 includes a riving knife, or splitter 30, a top guard 50, and a latch 90 to removably attach the top guard 50 to the riving knife 30.

The riving knife 30 extends upward from the top surface 13 of the table saw 10 through the slot 14. The riving knife 30 may be mounted to the table saw 10. For example, the riving knife 30 may be mounted to the carriage (not shown) under the table 12 in such a manner so that it is centered behind or aligned with the saw blade 16. In some embodiments, the riving knife 30 may be mounted for movement in conjunction with the saw blade 16.

The riving knife 30 operates to keep the cut portion of the workpiece (not shown) split or separated after it is cut and as the remainder of the workpiece is fed through the saw blade 16. Splitting or keeping the cut portions of the workpiece separated helps to prevent potential binding of the saw blade 16 during operation. The spacing of the riving knife 30 from the saw blade 16 may range from about 3 mm (0.12 inches) to 8 mm (0.31 inches) to reduce the possibility for binding and kickback.

A top guard 50 is attached to the riving knife 30. Desirably, the top guard 50 is attached to an upper portion of the riving knife 30 so that the workpiece does not contact the top guard 50. The Applicants have disclosed several suitable structures to removably attach the top guard 50 to the riving knife in previous patent applications. For example, the Applicants have disclosed suitable structure in commonly assigned U.S. Ser. No. 10/601,721 filed on Jun. 23, 2003, which is hereby fully incorporated herein by reference. Similarly, the Applicants have disclosed a different mechanism suitable to removably mount the top guard 50 to the riving knife in U.S. Ser. No. 11/333,854, filed on Jan. 17, 2006 and is commonly assigned. Accordingly, the Applicants fully incorporate this application herein by reference.

The top guard 50 is formed with a first finger 52 and a second finger 54 that extend forwardly from the point of contact between the top guard 50 and the riving knife 30. The two fingers 52, 54 are sized to extend past the front edge 17 of the saw blade 16. Thus, the two fingers 52, 54 provide protection from the user contacting the saw blade 16 from above the saw blade 16. The two fingers 52, 54 are spaced from each other to form a gap 53 that provides a view of the saw blade 16 and the workpiece as it is moved toward and contacts the saw blade 16. The gap 53 provides the user with a suitable view of alignment markings (not shown) on the workpiece to allow the user to precisely cut the workpiece with the saw blade 16.

The top guard 50 may also include a side guard 70 pivotably mounted to the top guard 50. The side guard 70 normally contacts the workpiece yet allows the workpiece to move into the cutting zone while providing a protective surface that surrounds the front and the sides of the exposed portion of the saw blade 16. The side guard 70 may include side pieces 72 and 74 that extend beyond the fingers 52, 54 of the top guard 50. The side pieces 72, 74 provide protection from the saw blade 16 both before and after the workpiece is cut. Likewise, the side guard 70 has a front portion 76 that contacts an operator's hands or fingers that are on top of the workpiece as it is fed to be cut, thus providing a tactile warning that the operator's hands or fingers may be near the saw blade 16. The side guard 70 is designed not to interfere with measuring, aligning, or setting up the workpiece due to its pivotal mounting.

In one embodiment, the riving knife 30 may be formed from a flat plate that extends through the slot 14 in the table 12. The riving knife 30 is movably mounted to the table saw 10. The riving knife 30 is formed to maintain separation between the two portions of the workpiece after the workpiece is cut by the saw blade 16. The forward edge 32 of the riving knife 30 is formed to be concave with a radius slightly larger than the radius of the saw blade 16. This shape allows the forward edge 32 of the riving knife 30 to substantially surround the rear edge 19 of the saw blade 16 while the saw blade 16 is rotating to provide protection for the user against accidental contact between the user and the rear edge 19 of the saw blade 16.

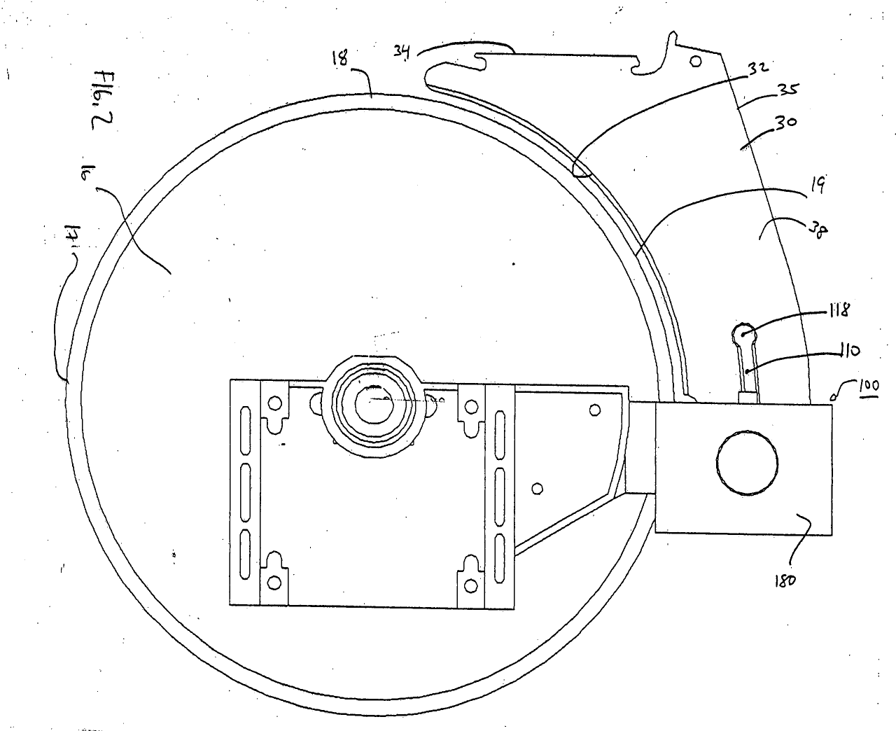

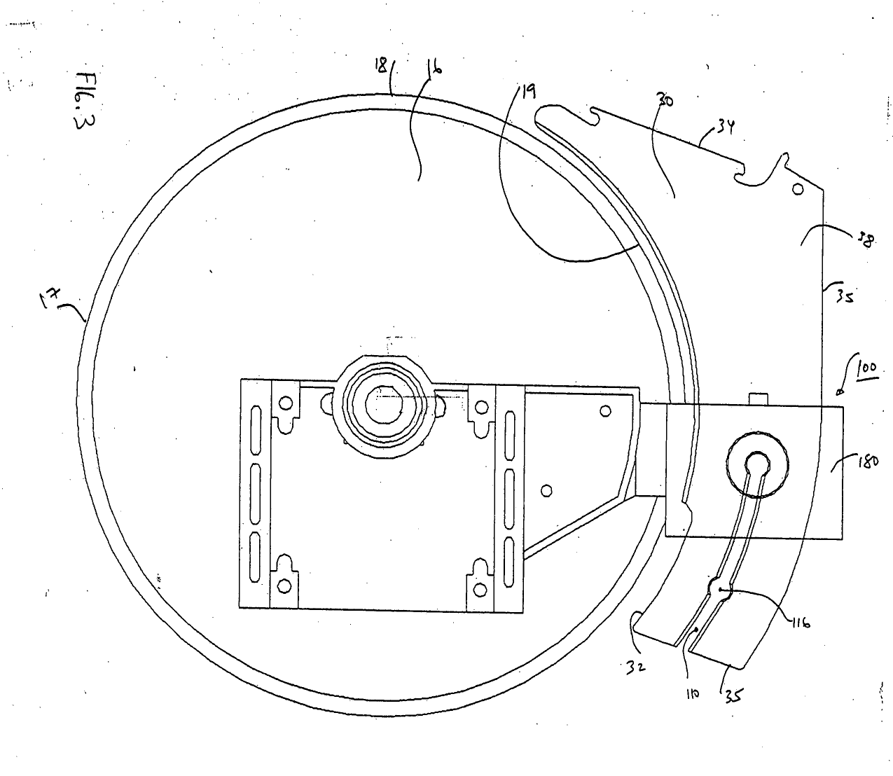

The riving knife is movable with respect to the table 12 and saw blade 16 from a first position (FIG. 2) where the riving knife surrounds the rear edge 19 of the saw blade 16 as well as a portion of the top edge 18 of the saw blade 16 to a second position (FIG. 3) where the riving knife 30 only surrounds a portion of the rear edge 19 of the saw blade 16. In the second position, the upper most point of the riving knife 30 is lower than the top edge 18 of the saw blade 16. This orientation allows the user to make non-through cuts on a workpiece without removing the riving knife 30 from the table saw 10. As discussed above, the ability to easily and quickly move the riving knife 30 to and from this position significantly reduces the user's motivation to operate the table saw 10 without a riving knife 30.

Turning now to FIGS. 2-10, the table saw 10 may include a riving knife adjustment mechanism 100 to permit adjustment of the fixed position of the riving knife 30 with respect to the saw blade 16. The riving knife 30 is adjustable to a plurality of positions between a first position (FIG. 2) where the riving knife 30 is orientated above and at least partially surrounding the saw blade 16 to a second position (FIG. 3) where the riving knife 30 surrounds the majority of the rear edge 19 of the saw blade 16 but is lower than the top edge 18 of the saw blade 16. As can be understood by those of ordinary skill in the art, the position of the riving knife 30 shown in FIG. 3 is useful to perform non-through cuts of a workpiece without removing the riving knife 30 from the table saw 10.

As shown in FIG. 2, the riving knife 30 includes a front edge 32, a top edge 34, a bottom edge 33, and a rear edge 35. The front and rear edges 32, 35 may be formed with a curvature similar to the curvature of the saw blade 16. The front edge 32 is formed with a radius slightly larger than the saw blade 16 to allow the front edge 32 of the riving knife 30 to be positioned close to the rear edge 19 (and surround a portion of the top edge 18 of the saw blade 16 when the riving knife 30 is in the first position) to provide protection for the user from contacting the saw blade 16 during rotation and to provide a surface to separate the cut sections of the workpiece apart to prevent workpiece kickback. The rear edge 35 of the riving knife 30 may be formed with a curve similar to the curve of the front edge 32.

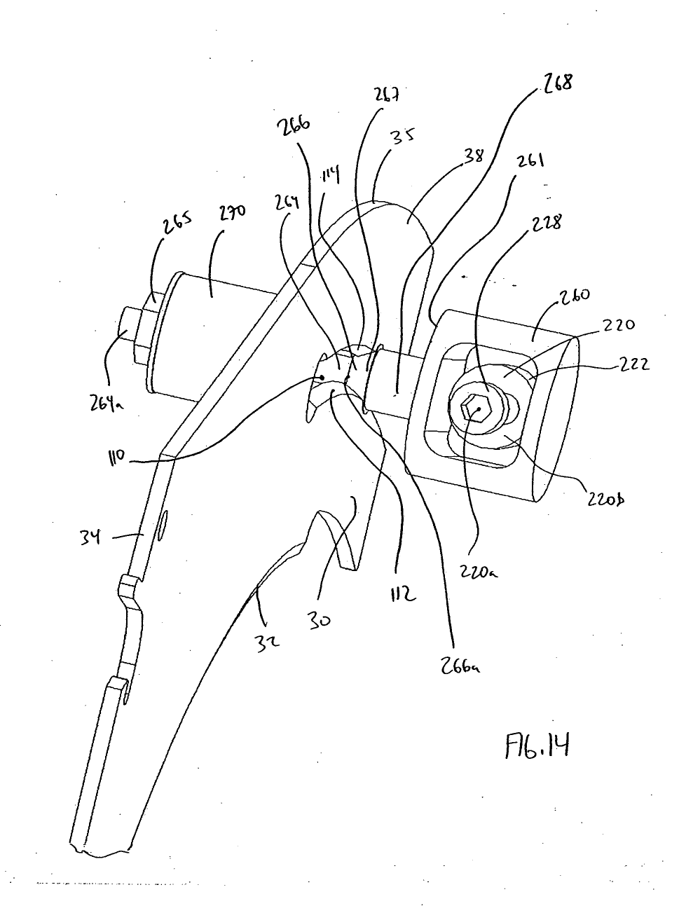

As mentioned above, the riving knife 30 includes a slot 110 that extends from the bottom edge 33 of the riving knife 30 upward along a portion of the riving knife 30. The slot 110 is curved with a similar shape as the front edge 32, with a radius equal to the sum of the radius of curvature the front edge and the distance between the slot 110 and the front edge 32 along the bottom edge of the riving knife 33. As best shown in FIG. 14, the slot 110 may be formed with front and rear edges 112, 114 that are oriented at an oblique angle with respect to a second side surface 38 of the riving knife 30. In other words, the distance between the front and rear edges 112, 114 is greater on the second side 38 of the riving knife 30 than the first side 36 of the riving knife, and the interior surface of each of the front and rear edges 112, 114 is flat. In other embodiments, the edges 112, 114 of the slot 110 may be parallel to each other, but the edges within the recesses 116, 118 (discussed below) may each be oblique with respect to the side surfaces of the riving knife 30 as discussed above.

The slot 110 includes a plurality of recesses 116, 118 that allows the riving knife 30 to be retained in a plurality of selected positions with respect to the saw blade 16. The riving knife includes at least a lower recess 116 and an upper recess 118. As shown in FIGS. 2 and 3, the upper recess 118 is located at the top of the slot 110 and the lower recess 116 is located approximately half way up the slot 110 from the bottom edge 33 of the riving knife 30. In other embodiments, the recesses 116, 118 can be provided separately from the slot 110. As can be understood with reference to the figures, the riving knife 30 is retained in the first position (FIG. 2) when the first pin 130 (discussed in detail below) is positioned within the lower recess 116, and the riving knife 30 is retained in the second position (FIG. 3) when the first pin 130 is retained in the upper recess 118.

The slot 110 can be formed to include additional recesses that allow the riving knife to be positioned in other orientations with respect to the saw blade 16 and the table 12. The riving knife may be removed from the adjustment mechanism 100 when the riving knife 30 is unlocked (as explained below) by withdrawing the riving knife 30 upward through the slot 14 in the table 12. When the riving knife 30 is to be restored to the table 12, the riving knife 30 is lowered through the slot 14 with the first pin 130 positioned within the slot 110.

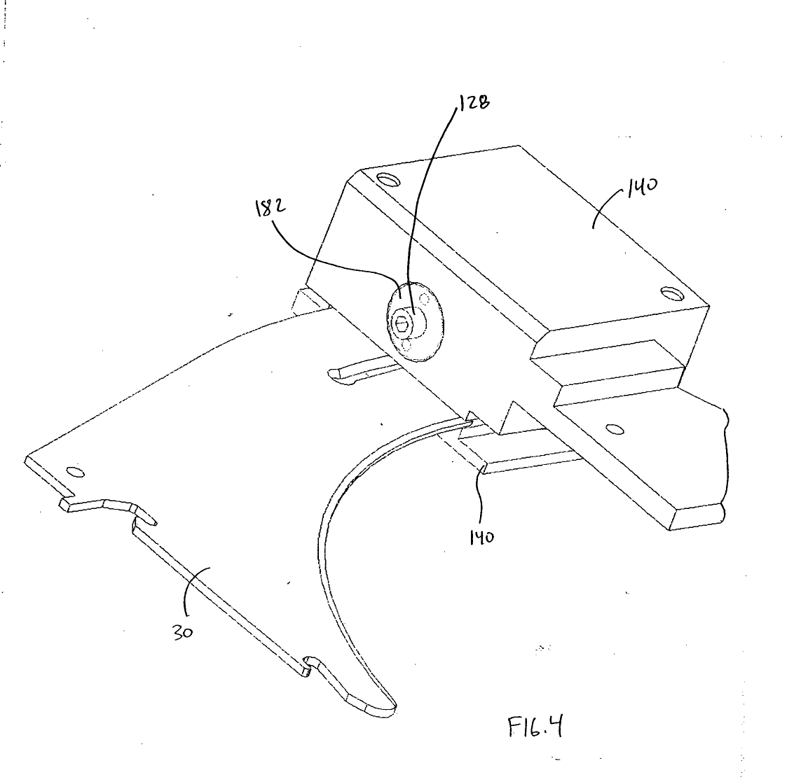

A representative embodiment of the adjustment mechanism 100 is discussed below with reference to FIGS. 4-10. The adjustment mechanism 100 generally includes the riving knife 30 and a clamp plate 140 that is movable to selectively contact a first side surface 36 of the riving knife 30. The adjustment mechanism 100 includes a rotatable cam 120 that contacts a first cam follower that is formed as a first pin 130 and also contacts a bracket 160 that acts as a second cam follower. The bracket 160 and the cam 120 are enclosed within a housing 180 that serves as the mounting structure for the components of the adjustment mechanism 100. In some embodiments, the housing 180 is mounted to the table 12, in other embodiments the housing 180 may be mounted to a frame (not shown) in the table saw 10.

The riving knife 30 is maintained in the selected position with respect to the saw blade 16 and the table 12 when the riving knife 30 is positioned between the clamp plate 140 and the housing 180. The clamp plate 140 may be movably mounted to the housing 180 with a plurality of bolts 146 or other similar fasteners, and a plurality of springs 148 that allow for linear movement of the clamp plate 140 with respect to the housing 180 and bias the clamp plate 140 toward the housing 180. Normally, the biasing force of the springs 148 exert a compressive force on the clamp plate 140 so that a side surface (not shown) contacts the first side 36 of the riving knife 30 and causes the second side 38 of the riving knife 30 to contact a side surface (not shown) of the housing 180. The springs 148 cause these components to be in compression when the cam 120 (discussed below) is in the first position and the normal forces felt on each side surface 36, 38 of the riving knife cause a frictional force sufficient to retain the riving knife 30 in the selected position.

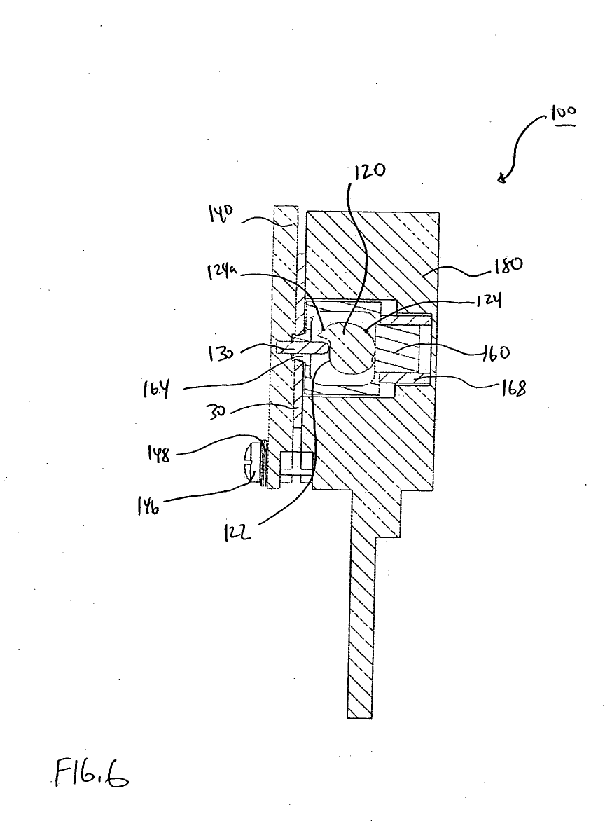

As discussed below, the clockwise rotation (from the view of FIG. 6) of the cam 120 causes the clamp plate 140 to translate away from the riving knife 30 against the force of the springs 148. The springs 148 on the bolts, or other similar fasteners, are formed from a plurality of Belleville washers that are placed in series. In other embodiments, the springs 148 can be formed from helical springs or similar other components known in the art that store energy when compressed and exert a biasing force on a neighboring member.

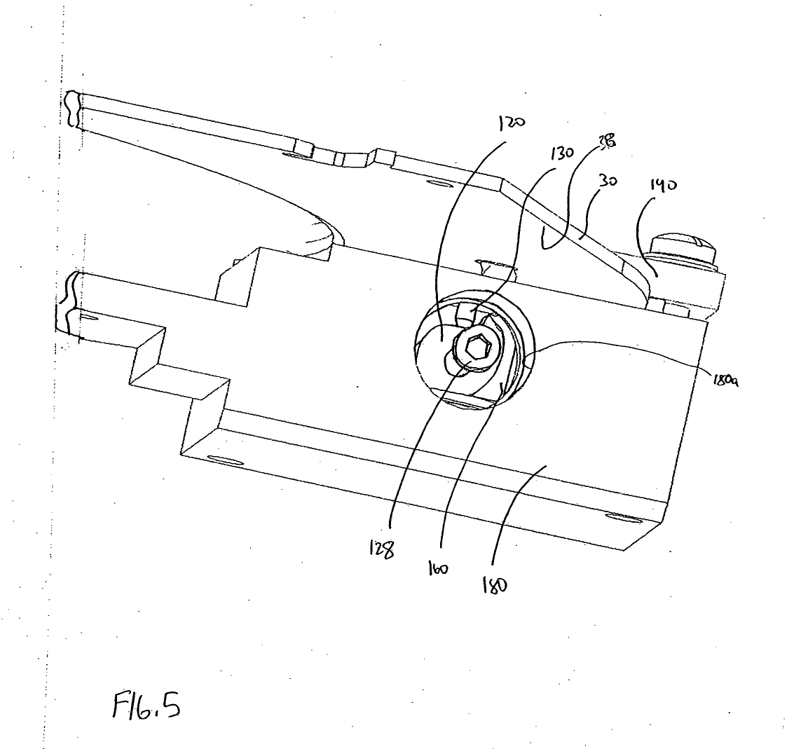

The cam 120 (best shown in FIGS. 4-9) is rotatably positioned within the housing 180. The housing 180 preferably has a threaded aperture 180a (FIG. 5) that receives a corresponding threaded plug 182 (FIG. 4). The plug 182 includes a central aperture (not shown) that receives a hex bold 128 (or similar member) that extends from the cam and may be rotated to cause similar rotation of the cam 120. The housing 180 is positioned directly below the table 12 and the table 12 includes an aperture to allow the cam 120 to be rotated from above the table 12. Preferably, the table 12 includes a removable plate 12a (FIG. 1) that when removed exposes the cam 120 for manipulation. The removable plate 12a encloses the housing 180 and the cam 120 and provides an uninterrupted surface for the workpiece to slide after passing the saw blade 16 when it is installed on the table 12.

The cam 120 includes a first cam surface 122 that contacts the first pin 130 (that extends through the slot 110 in the riving knife 30) and acts as a first cam follower. The cam 120 includes a second cam surface 124 that contacts the bracket 160 that acts as a second cam follower.

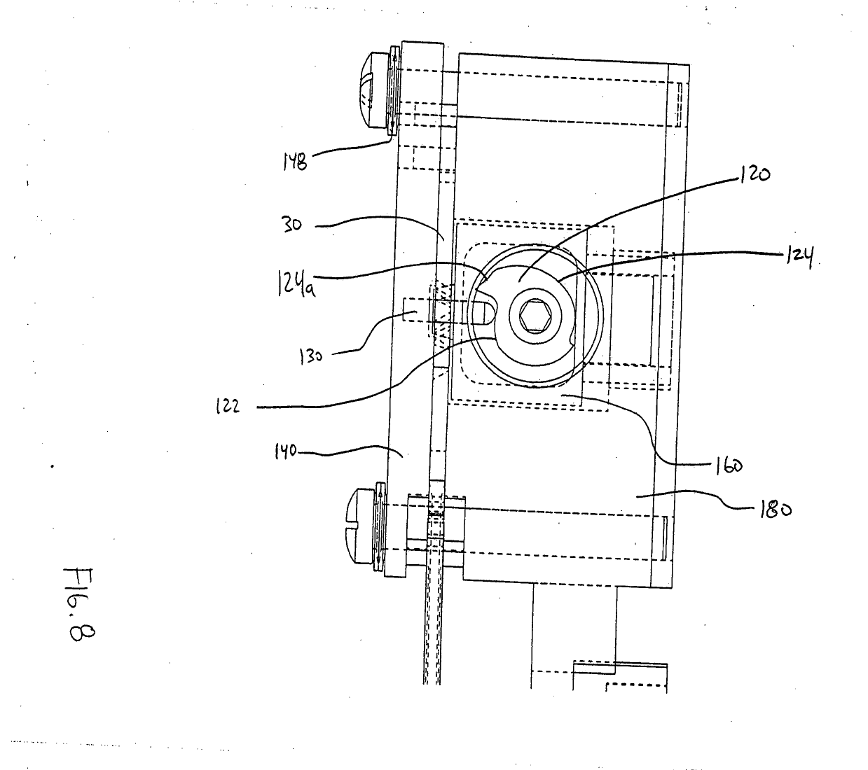

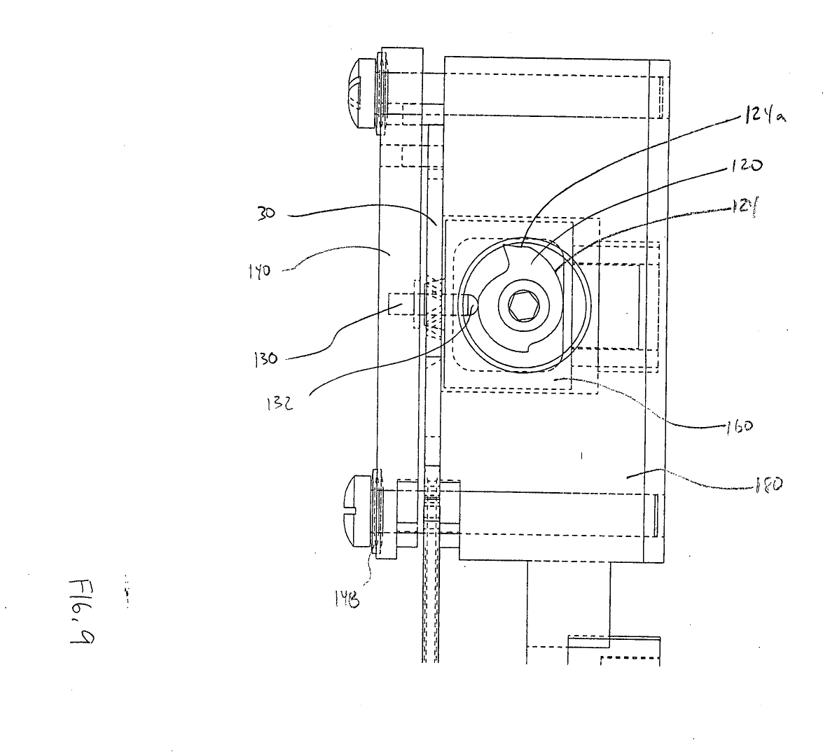

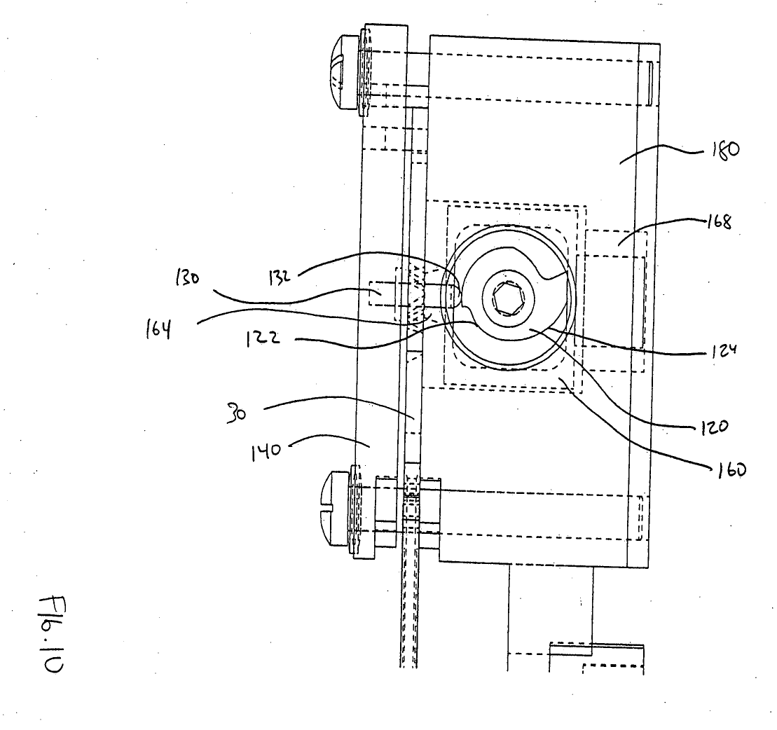

The cam 120 is rotatable between a first position (FIG. 8) and a second position (FIG. 10). When the cam 120 is in the first position, each of the first pin 130 and the bracket 160 contact the first cam surface 122 and the second cam surface 124, respectively, at the smallest diameter of each of the two cam surfaces 122, 124. In the second position, the bracket 160 contacts a release surface 124a on the second cam surface 124 that is the largest diameter of the second cam surface 124. The first cam surface 122 reaches its largest diameter at a midpoint (FIG. 9) between the first position and second positions of the cam 120 and retains the largest diameter until the cam 120 reaches the second position.

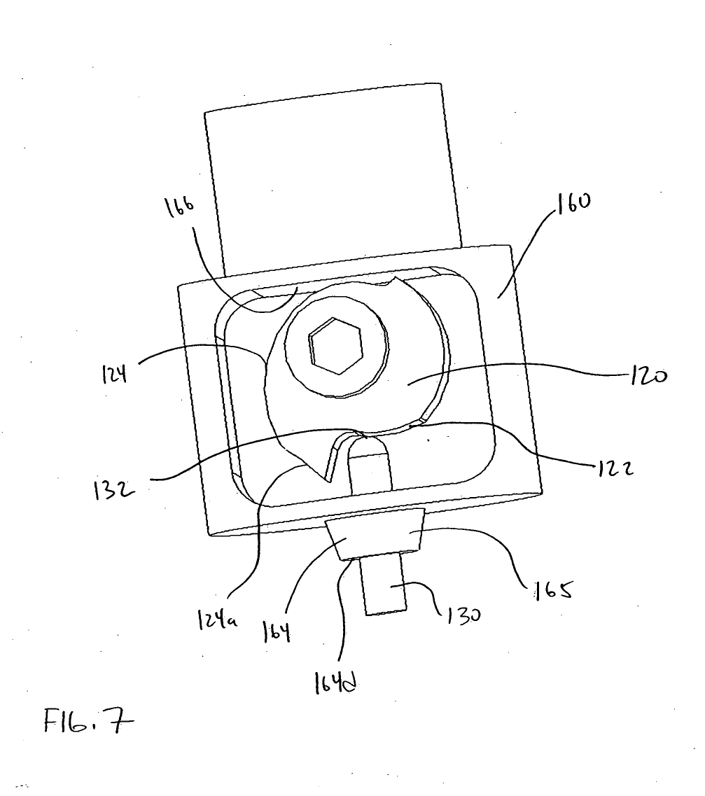

A first end 132 of the first pin 130 contacts the first cam surface 122. The first pin 130 extends through the slot 110 in the riving knife 30 and a second end (not shown) is retained by the clamp plate 140. As can be understood by viewing FIGS. 7-9, rotation of the cam 120 causes lateral motion of the clamp plate 140 against the biasing force of the springs 148, such that with sufficient rotation of the cam 120 the clamp plate 140 no longer contacts the first side surface 36 of the riving knife 30. Because the first cam surface 122 is formed with a substantially constant diameter after the rotational position where the clamp plate 140 is moved from the riving knife 30 (or the compression force felt by the riving knife 30 is significantly reduced to allow the riving knife 30 to be adjusted), the clamp plate 140 remains in substantially the same position with respect to the riving knife 30 with continued rotation of the cam 120 toward the second position.

The bracket 160 is best shown in FIGS. 5 and 6. The bracket 160 includes a cam follower surface 166 and a forward surface 167. The bracket 160 is formed such that it substantially surrounds the cam 120, with the cam follower surface 166 contacting the second cam surface 124 and the forward surface 167 formed with an aperture that allows the first pin 130 to extend therethrough. The forward surface 167 is formed with a tapered pin 164 extending away from the cam follower surface 166. The center of the tapered pin 164 is formed with a hole extending therethrough, which movably accepts the first pin 130. The tapered pin 164 includes a conical side wall 165 formed with a complementary angle to that formed between the front and rear edges 112, 114 of the slot 110 and the second surface 38 of the riving knife 30. As best seen in FIG. 6, the tapered pin 164 is dimensioned to fit within each of the recesses 116, 118 in the slot 110 of the riving knife 30.

As shown in FIG. 6, the bracket 160 is preferably biased toward the riving knife 30 with a spring 168. The spring 168 is positioned between the bracket 160 and the housing 180. The bracket 160 is normally urged by the spring 168 to insert the tapered pin 164 into the selected recess 116, 118.

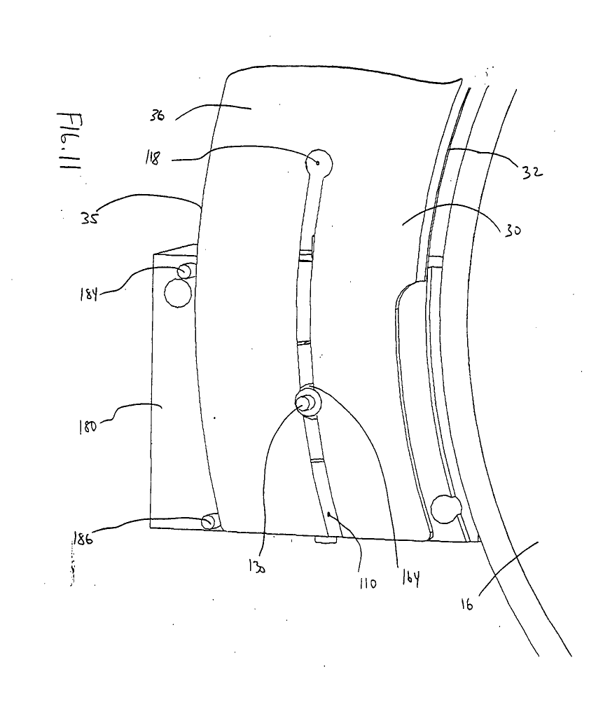

In addition to the components and features of the housing 180 discussed above, as shown in FIG. 11, the housing preferably includes a plurality of pins 184, 186 that are formed with or rigidly attached to the housing 180. The pins 184, 186 extend from the housing toward the clamp plate 140. The pins 184, 186 contact the rear edge 35 of the riving knife 30 in all possible positions of the riving knife 30. Therefore, when the cam 120 is in the first position, the riving knife 30 contacts each of the clamp plate 140, the housing 180, the second and third pins 184, 186, and the tapered pin 164 is inserted into one of the recesses 116, 118 of the riving knife 30. In this position, the riving knife 30 is constrained in all three directions of lateral movement and prevented from rotation about all three axes. Accordingly, in this position, the riving knife 30 is rigidly attached to the table 12, which may provide a stable support for the top guard 50 or other structures that maybe mounted to the riving knife 30.

In operation, the user may adjust the position of the riving knife 30 with respect to the saw blade 16 in the following manner. Initially, the user removes the removable plate 12a provide access to manipulate the hex bolt 128. The user rotates the hex bolt 128 (or other appropriate structure for rotation of the cam 120) to transfer the cam 120 from the first position toward the second position. With sufficient rotation of the cam 120, the first pin 130 is translated away from the cam follower surface 166 of the bracket 160, which causes the clamp plate 140 to no longer contact the first side 36 surface of the riving knife 30 or to no longer exert a significant amount of compressive force on the riving knife 30. As the cam 120 is further rotated toward the second position, the bracket 160 is moved away from the riving knife 30 against the biasing force of the spring 168. When the cam 120 reaches the second position, the tapered pin 164 is withdrawn from the selected recess 116, 118. In this position, the riving knife 30 can be moved substantially upward or downward (along the curvature of the slot 110) to shift the position of the riving knife 30 with respect to the saw blade 16 to a new desired position or to remove the riving knife 30 from the table saw 10.

After the riving knife 30 has been placed in the desired position or replaced in the table saw 10, the user rotates the cam 120 in the opposite direction toward the first position. As the cam 120 is rotated, the bracket 160 moves toward the riving knife 30 due to the biasing force of the spring 168, which moves the tapered pin 164 toward the riving knife 30. With sufficient rotation of the cam 120, the forward flat surface 164d of the tapered pin 164 contacts the second side surface 38 of the riving knife 30. Alternatively, the tapered pin 164 will enter one of the plurality of recesses 116, 118, if it is so aligned. If the forward surface 164d contacts the riving knife 30, the user makes minor adjustments to the position of the riving knife 30 until the user senses an audible noise or a tactile vibration on the riving knife 30 that the tapered pin 164 has entered one of the recesses 116, 118. When the tapered pin 164 is aligned with one of the recesses 116, 118, continued rotation of the cam 120 causes the tapered pin 164 to extend further into the recess, as it is urged toward the riving knife 30 by the spring 168.

At a midpoint of the rotation of the cam 120 (FIG. 9), the first pin 130 contacts the decreasing diameter section of the first cam surface 122. Because the diameter of the first cam surface 122 decreases as the cam 120 is rotated toward the first position, the first pin (and accordingly the clamp plate 140 that is in contact with the first pin 130) moves toward the riving knife 30 due to the biasing force of the compressed springs 148. When the cam 120 reaches the first position, the clamp plate 140 contacts the riving knife 30 to sandwich the riving knife 30 between the clamp plate 140 and the housing 180. In this position, the riving knife 30 is again constrained from lateral motion in all three directions and prevented from rotation about all three axes in conjunction with pins 184, 186.

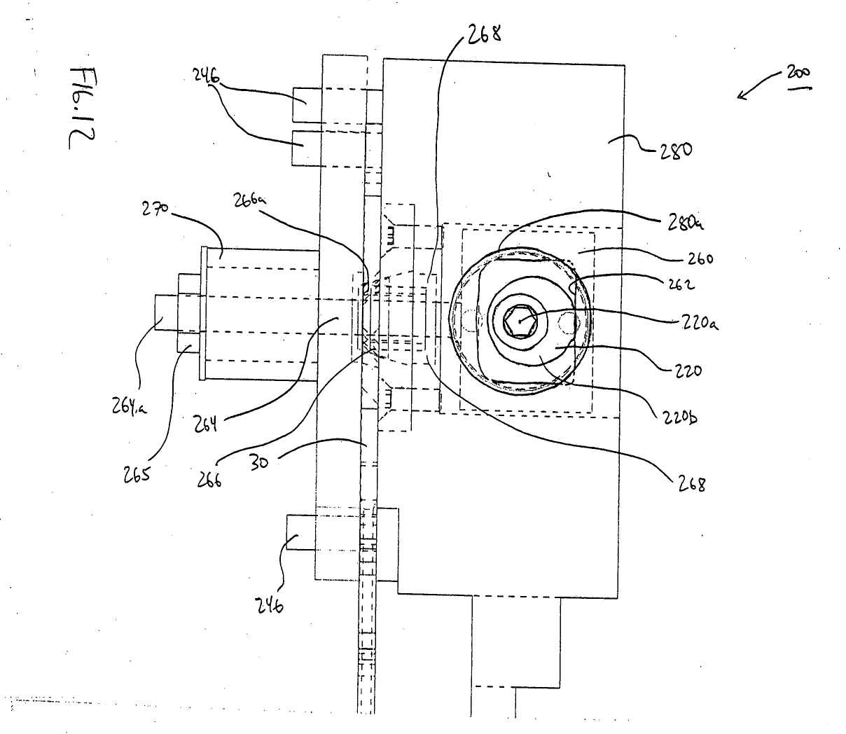

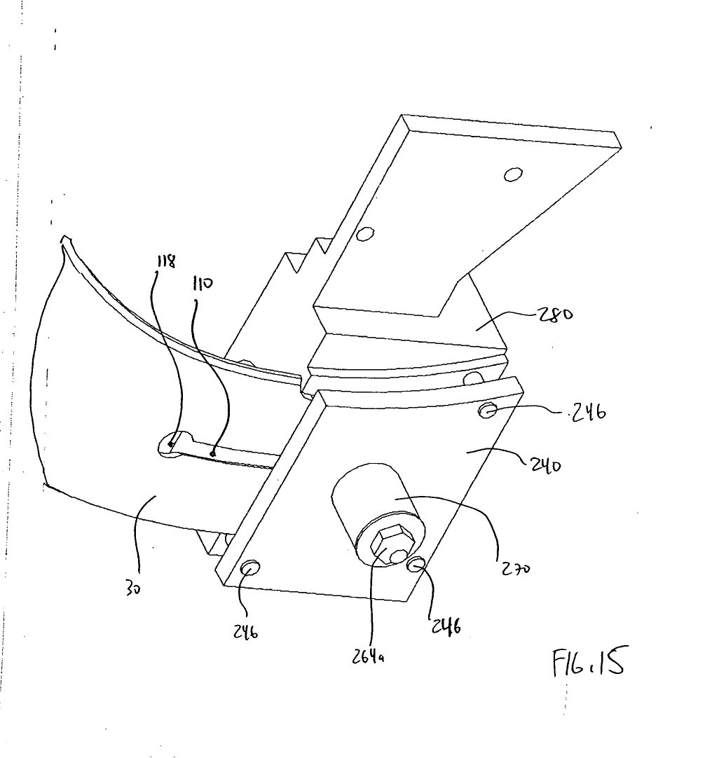

A second embodiment of the adjustment mechanism 200 is provided and shown in FIGS. 12-15. The adjustment mechanism 200 generally includes a riving knife 30 and a clamp plate 240 that is movable to selectively contact a first side surface 36 of the riving knife 30. The adjustment mechanism 200 further includes a rotatable cam 220 that moves a bracket 260 linearly, which releasably locks the riving knife 30 in the selected position with respect to the table 12 and the saw blade 16. The bracket 260 and the cam 220 are enclosed within a housing 280 that is the mounting structure for the components of the adjustment mechanism 200.

The riving knife 30 is positioned between a clamp pate 240 and the housing 280. The clamp plate 240 may be movably mounted to the housing 280 with a plurality of shafts 246, or other similar fasteners. The shafts 246 allow the clamp plate 240 to move linearly toward and away from the riving knife 30, but constrain the clamp plate 240 from translating or rotating in any other direction. The clamp plate 240 additionally is mounted to accept a pin 264 that is mounted to the bracket 260 and extends through the slot 110 and an aperture (not shown) in the clamp plate 240. An end 264a of the pin 264 is preferably threaded and receives a nut 265. A spring 270 is positioned between the nut 265 and the clamp plate 240 to bias the clamp plate 240 toward the riving knife 30 when the spring 270 is compressed, which aids in locking the riving knife 30 by exerting a compressive force on the riving knife 30 between the clamp plate 240 and the housing 280.

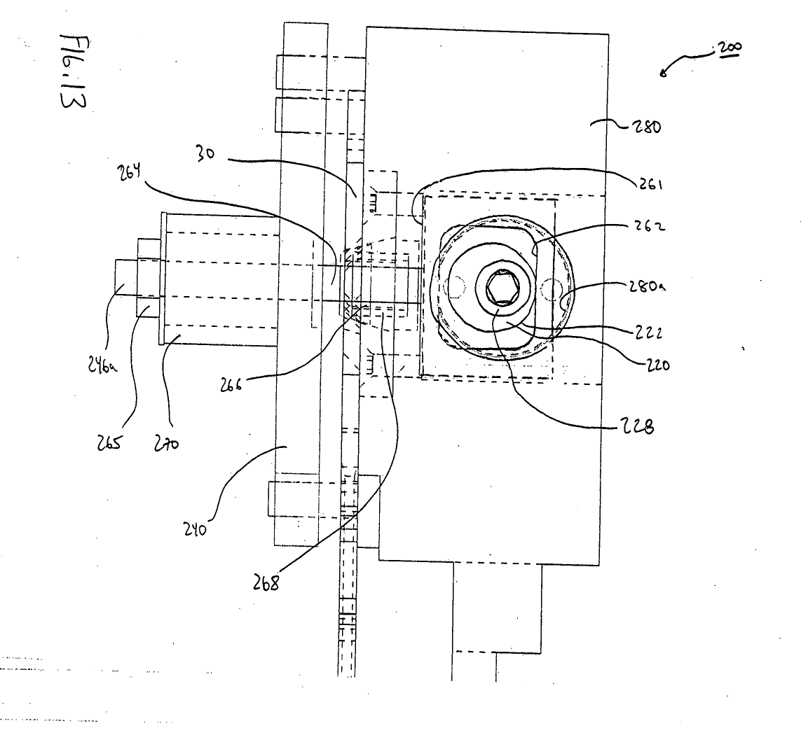

As can be seen with reference to FIGS. 12 and 13, the pin 264 translates with the bracket 260 due to the rotation of the cam 220. Similar to the embodiment discussed above, the cam 220 is rotatably positioned within the housing 280. The housing 280 has a threaded aperture 280a that receives a correspondingly threaded plug (not shown). The plug is similar to, and makes similar engagement with the housing 280, as the plug 182 discussed in the discussing of the embodiment above, and shown in FIG. 4. As with the plug 182, the plug that engages the housing 280 of the current embodiment includes a central aperture that receives a hex bolt 228 (or similar member) that extends from the cam 220 and may be rotated to cause similar rotation of the cam 220.

The housing 280 is positioned directly below the table 12, which includes an aperture 280a to allow the cam 220 to be rotated from above the table 12. Preferably, the table 12 includes a removable plate 12a that when removed exposes the cam 220 for manipulation and when in position on the table 12 encloses the housing 280 and the cam 220 and provides an uninterrupted surface for the workpiece to slide on after being cut by the saw blade 16.

As shown in FIGS. 12 and 13, the cam 220 is rotatable between a locked position (FIG. 12) and a release position (FIG. 13), and includes a cam surface 222 that contacts a follower surface 262 of the bracket 260. As with many cam designs, the diameter of the cam at the point of contact with the follower surface 262 changes as the cam 220 is rotated. When the cam 220 is in the locked position, the distance between the rotational axis of the cam (not shown but as can be understood, the rotational axis extends through point 220a on FIG. 12 perpendicularly to the top surface 220b of the cam 220) and the point of contact is greater than the same dimension when the cam 220 is in the release position.

The bracket 260 is best shown in FIGS. 12-14. The bracket 260 includes a cam follower surface 262 and a pin 264 that is rigidly connected to a forward end 261 of the bracket 260. The pin 264 supports a second spring 268 and a tapered pin 266, while allowing each of these components to freely translate along the pin 264. The tapered pin 266 includes an aperture (not shown) that the pin 264 extends therethrough. The tapered pin 266 includes a conical side wall 267 formed with a complementary angle to that formed by the front and rear edges 112, 114 and/or the recesses 116, 118 of the slot 110 with respect to the second side surface 38 of the riving knife 30. As is best shown in FIG. 14, the tapered pin 264 is dimensioned to fit within each of the recesses 116, 118 in the slot 110 of the riving knife, when the cam 220 is in the locked position (FIG. 12). The second spring 268 is positioned between a wall of the housing 280 and biases the tapered pin 266 toward the riving knife 30.

In operation, the user may adjust the position of the riving knife 30 with respect to the saw blade 16 as follows. Initially, the user removes the plate 12a from the table 12 to allow for access of the cam 220. The user rotates the hex driver 228 (or other appropriate member for rotation of the cam 220) to transfer the cam 220 from the locked position toward the release position. As cam 220 is rotated, the distance between the contact point of the cam surface 222 and the rotational axis (located at 220a) of the cam decreases, which allows the bracket 260 to move toward the riving knife 30. As the diameter of the cam 220 decreases, the spring 270 expands, and pulls the bracket 260 and pin 264 toward the left, or pulls the bracket 260 toward the riving knife 30, because of the biasing force of the spring 270. As the spring 270 expands, it reduces the compressive force on the clamp plate 240, which therefore reduces the compression on the riving knife 30 between the clamp plate 240 and the housing 280.

With sufficient rotation of the cam 220, the spring 270 slightly relaxes and compression forces between the clamp plate 240, the riving knife 30, and the housing 280 are similarly relaxed, allowing the riving knife to be repositioned by the user. As the riving knife 30 is moved, the relative motion between the riving knife 30 and the tapered pin 266 causes the tapered pin 266 to be pushed rightward against the biasing force of the second spring 268 away from the respective recess 116, 118. Once the tapered pin 266 has exited the respective recess, the riving knife 30 may be moved to a new position with respect to the saw blade 16, or alternatively, can be removed from the table saw 10.

When the riving knife 30 has been placed in the desired orientation, the user rotates the cam 220 in the opposite direction. If the riving knife is in a position where the tapered pin 266 is aligned with a recess 116, 118, the tapered pin 266 snaps into engagement with the recess 116, 118 because of the biasing force of the second spring 268. Alternatively, if the tapered pin 266 is not aligned with a recess 116, 188, the forward end 266a makes contact with the second side 38 of the riving knife 30. In this situation, the user moves the riving knife 30 until they sense that the tapered pin 266 has engaged the appropriate recess, either through an audible or a tactile signal. As the cam 220 is rotated toward the locked position, the diameter of the cam surface 222 increases, causing the bracket 260 to move away from the riving knife 30 and the pin 264 to move rightward through the slot 110. This additionally compresses the spring 270 and increases the compressive forces between the clamp plate 240, the riving knife 30, and the housing 280.

The foregoing disclosure is the best mode devised by the inventors for practicing this invention. It is apparent, however, that apparatus incorporating modifications and variations will be obvious to one skilled in the art. Inasmuch as the foregoing disclosure is intended to enable one skilled in the pertinent art to practice the instant invention, it should not be construed to be limited thereby but should be construed to include aforementioned obvious variations and be limited only by the spirit and scope of the following claims.

It is therefore intended that the foregoing detailed description be regarded as illustrative rather than limiting, and that it be understood that it is the following claims, including all equivalents, that are intended to define the spirit and scope of this invention.

1. A table saw comprising:
(a) a table including an aperture to receive a portion of a rotatable saw blade extending from below the table;
(b) a riving knife extending through the aperture from below the table, wherein the riving knife includes a slot that receives a first pin and the riving knife includes a plurality of recesses; and
(c) a cam that operatively engages the first pin and is rotatable to cause linear motion of the first pin with respect to the slot such that when the cam is in a first position the riving knife may be retained in a selected position and when the cam is in a second position the riving knife may be movable to another selected position, wherein the rotation of the cam additionally causes movement of a second pin that may be received within one of the plurality of recesses.

2. The table saw of claim 1 wherein the plurality of recesses are each formed with a first and a second wall that are each oriented at an oblique angle with respect to a side surface of the riving knife that faces the cam.

3. The table saw of claim 2 wherein the second pin is formed with a substantially complementary angle to the angle of the first and second walls of the plurality of recesses.

4. The table saw of claim 1 wherein the cam includes a first cam surface that contacts the first pin.

5. The table saw of claim 1 wherein the first pin extends through a hole in the second pin and the second pin is movable with respect to the first pin.

6. The table saw of claim 4 wherein the second pin is attached to a bracket, wherein the cam includes a second cam surface that contacts the bracket.

7. The table saw of claim 6 wherein the bracket is biased toward the riving knife by a spring.

8. The table saw of claim 1 wherein the first pin is engaged by a clamp plate that selectively contacts the riving knife based on the position of the cam.

9. The table saw of claim 8 wherein the clamp plate exerts a compressive force on a side surface of the riving knife when the cam is in a first position and the compressive force is reduced from the riving knife when the cam is rotated toward a second position.

10. The table saw of claim 8 wherein the clamp plate is biased toward the riving knife by a spring.

11. The table saw of claim 1 wherein the cam and the pin are partially enclosed within a housing.

12. The table saw of claim 11 wherein the housing fixedly supports a third pin that contacts the riving knife to control the range of motion of the riving knife with respect to the saw blade.

13. The table saw of claim 1 wherein the table includes an aperture to allow the user to rotate the cam from above the table and a cover plate to selectively cover the aperture when the table saw is in use.

14. A table saw comprising:
(a) a table including an aperture to receive a portion of a rotatable saw blade extending from below the table;
(b) a riving knife extending through the aperture from below the table, wherein the riving knife includes a slot that receives a first pin to retain the riving knife in a selected position with respect to the saw blade, the riving knife including a plurality of recesses;
(c) a second pin surrounding a portion of the first pin and moveable with respect to the first pin;
(d) a clamp plate moveably engageable with the riving knife and operatively engaged with the first pin; and
(e) a cam operatively connected to the first pin, wherein the cam is rotatable between a first position where the clamp plate exerts a compressive force on the riving knife and a second position where the compressive force is reduced from the riving knife, and wherein the second pin is engageable with one of the plurality of recesses when the cam is in the first position and disengageable with the plurality of recesses when the cam is rotated toward the second position.

15. The table saw of claim 14 further comprising a bracket that is linearly movable when the cam rotates between the first and second position.

16. The table saw of claim 15 wherein the cam comprises a first cam surface that engages the bracket.

17. The table saw of claim 16 wherein a larger diameter portion of the first cam surface contacts the bracket when the cam is in the first position, and a smaller diameter portion of the first cam surface contacts the bracket when the cam is in the second position.

18. The table saw of claim 15 where in the second pin is biased toward the riving knife with a first spring.

19. The table saw of claim 18 wherein the clamp plate is biased toward the riving knife with a second spring.

20. The table saw of claim 19 wherein the first and second springs each surround the first pin.
